(19) United States
(12) Patent Application Publication
(10) Pub. No.: US 2022/0113802 A1
(43) Pub. Date: Apr. 14, 2022

(54) CONTROL DEVICE AND PROGRAM

(71) Applicant: KABUSHIKI KAISHA TOKAI RIKA DENKI SEISAKUSHO, Aichi (JP)

(72) Inventor: Aya KADONO, Aichi (JP)

(73) Assignee: KABUSHIKI KAISHA TOKAI RIKA DENKI SEISAKUSHO, Aichi (JP)

(21) Appl. No.: 17/421,888

(22) PCT Filed: Nov. 25, 2019
(86) PCT No.: PCT/JP2019/045994

§ 371 Date: Jul. 9, 2021

(30) Foreign Application Priority Data
Feb. 27, 2019 (JP) 2019-033829

(51) Int. Cl. G06F 3/01; G06F 3/038

(52) U.S. Cl. CPC G06F 3/016; A63F 13/285; G06F 3/038

(57) ABSTRACT

[Object] To notify a target more appropriately by means of a tactile stimulus, without being affected by a degree of contact between a tactile sense provision section and the target who operates a mobile object.

[Solution] Provided is a control device including: a contact degree detection section configured to detect a degree of contact between a target who operates a mobile object, and a tactile sense provision section that provides a tactile stimulus to at least a part of a body of the target during the operation; and a tactile sense provision control section configured to control a mode of the tactile stimulus to be provided by the tactile sense provision section, on a basis of the degree of contact.

### TECHNICAL FIELD

The present invention relates to a control device and a program.

### BACKGROUND ART

In recent years, devices of notifying a target who operates a mobile object (such as a car, for example) of occurrence of abnormality by means of a tactile stimulus (such as vibration, for example) have been widespread. For example, Patent Literature 1 listed below discloses a driving assistance device that makes it possible to adequately assist driving of a vehicle by combining a vibratory notification and a visual notification and allowing a driver with reduced auditory function to recognize a warning sound or the like around the driver.

### CITATION LIST

### Patent Literature

Patent Literature 1: JP 2015-001776A

### DISCLOSURE OF INVENTION

### Technical Problem

However, when using the technology disclosed in Patent Literature 1 or the like, sometimes it may be impossible to appropriately notify a target by means of a tactile stimulus, due to effects of a degree of contact between the target who operates a mobile object and an element that provides the tactile stimulus to the target (hereinafter, referred to as a “tactile sense provision section”). For example, in the case where the degree of contact between the target and the tactile stimulus provision section is weaker than a predetermined value, sometimes the target does not perceive the tactile stimulus when the tactile stimulus is provided uniformly. Alternatively, in the case where the intensity of the tactile stimulus is high enough to be certainly perceived by the target, sometimes the target may feel discomfort because the intensity of the tactile stimulus is too strong. Note that, examples of the case where it may be impossible to appropriately notify the target by means of the tactile stimulus are not limited to the above-described examples.

Accordingly, the present invention is made in view of the aforementioned issues, and the present invention provides a novel and improved control device and program that make it possible to notify a target more appropriately by means of a tactile stimulus, without being affected by a degree of contact between a tactile sense provision section and the target who operates a mobile object.

### Solution to Problem

To solve the above-described problems, according to an aspect of the present invention, there is provided a control device including: a contact degree detection section configured to detect a degree of contact between a target who operates a mobile object, and a tactile sense provision section that provides a tactile stimulus to at least a part of a body of the target during the operation; and a tactile sense provision control section configured to control a mode of the tactile stimulus to be provided by the tactile sense provision section, on a basis of the degree of contact.

In addition, in the case where the degree of contact falls below a threshold, the tactile sense provision control section may change the mode of the tactile stimulus in such a manner that the target has an increased sensitivity to the tactile stimulus.

In addition, in the case where the degree of contact falls below the threshold, the tactile sense provision control section may increase the sensitivity by chancing at least one of intensity, provision time, provision interval, and number of times of provision of the tactile stimulus.

In addition, the degree of contact may include intensity of the contact between the target and the tactile sense provision section or area of the contact between the target and the tactile sense provision section.

In addition, the contact degree detection section may estimate the degree of contact on the basis of a state of movement of the mobile object.

In addition, the tactile stimulus may include a vibratory stimulus, an electric stimulus, a stimulus provided when temperature changes, a stimulus related to a sense of force, or a stimulus related to a cutaneous sense.

In addition, the tactile sense provision control section may cause the tactile sense provision section to provide the tactile stimulus when an event to be announced occurs.

In addition, the mobile object may include a real or virtual vehicle, airplane, or ship.

In addition, the tactile sense provision section may be installed in a controller to be used for the operation, an armrest, a seat, or a seat belt.

In addition, to solve the above-described problems, according to another aspect of the present invention, there is provided a program that causes a computer to: detect a degree of contact between a target who operates a mobile object, and a tactile sense provision section that provides a tactile stimulus to at least a part of a body of the target the during operation; and control a mode of the tactile stimulus to be provided by the tactile sense provision section, on the basis of the degree of contact.

### Advantageous Effects of Invention

As described above, according to the present invention, it is possible to notify a target more appropriately by means of a tactile stimulus, without being affected by a degree of contact between a tactile sense provision section and the target who operates a mobile object.

### BRIEF DESCRIPTION OF DRAWINGS

FIG. 1 is a block diagram illustrating a configuration example of a control system according to the present embodiment.

FIG. 2 is a flowchart illustrating an example of a flow of a tactile stimulus provision control process that is performed by the control device according to the present embodiment.

### MODE(S) FOR CARRYING OUT THE INVENTION

Hereinafter, preferred embodiments of the present invention will be described in detail with reference to the appended drawings. Note that, in this specification and the appended drawings, structural elements that have substantially the same function and structure are denoted with the same reference signs, and repeated explanation of these structural elements will be omitted.

### <1. Configuration Example>

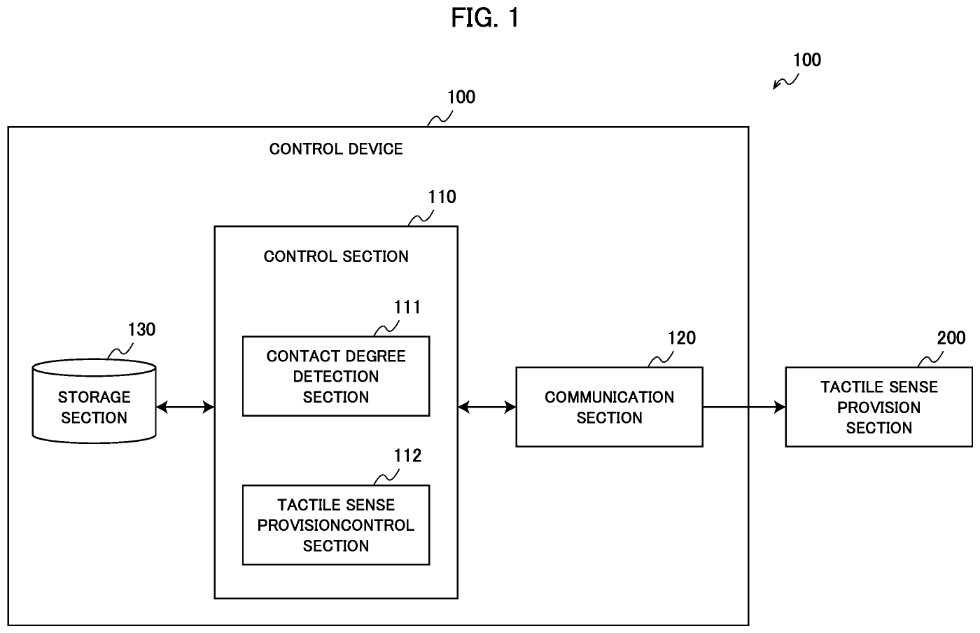

First, a configuration example of a control system according to an embodiment of the present invention will be described with reference to FIG. 1. FIG. 1 is a block diagram illustrating the configuration example of the control system according to the present embodiment. As illustrated in FIG. 1, a control system 1 according to the present embodiment includes a control device 100 and a tactile sense provision section 200.

### (Control System 1)

The control system 1 according to the present embodiment is a control system related to a mobile object. The control system 1 controls tactile stimulus notification to a target who operates the mobile object.

Here, the “mobile object” is a concept including a real or virtual vehicle, airplane, or ship. More specifically, examples of the mobile object include a real vehicle (such as a car, bus, motorcycle, locomotive, or train, for example), airplane (such as an aeroplane, helicopter, glider, or airship, for example), or ship (such as a passenger ship, cargo ship, or submarine, for example). In addition, the examples of the mobile object may include a virtual vehicle, airplane, or ship such as a simulator or a video game related to the vehicle, airplane, or ship. In addition, the examples of the mobile object may include a manned mobile object and an unmanned mobile object. For example, the examples of the mobile object may include an unmanned transport car, an unmanned aerial vehicle, an unmanned ship, a radio-controlled model, and the like that are remotely operated by the target. Note that, the mobile object is not necessarily limited to the above-described examples. Any object may be used as long as the object is movable. According to the present embodiment, an example in which the mobile object is the car will be mainly described.

In addition, the “tactile stimulus” used for notifying the target includes a vibratory stimulus, an electric stimulus, a stimulus provided when temperature changes a stimulus related to a sense of force (for example, a stimulus that provides a feeling of being pushed by an object, a stimulus that provides a feeling of coming into contact with an object, a stimulus that provides a feeling of tight pressure, or the like), or a stimulus related to a cutaneous sense (for example, a stimulus that provides a feeling of touching a textured surface, a stimulus that provides a feeling of touching a slick surface, or the like) or may be a combination thereof. For example, when making a notification by means of a stimulus such as sound, wind, or aroma, there is a possibility that such stimulus may affect not only the target (such as a driver, for example) but also passengers. However, by using the control system 1 according to the present embodiment, it is possible to notify the target alone by means of a tactile stimulus. Note that, the tactile stimulus is not limited to the above-described examples. Any stimulus may be used as long as the stimulus acts on the tactile sense of the target. According to the present embodiment, an example in which the tactile stimulus is the vibratory stimulus will be mainly described.

In addition, examples of the “notification” to the target include a notification of occurrence of abnormality. For example, the examples of the notification include a notification made in the case where the mobile object is likely to deviate (or has deviated) from a predetermined migration path (such as a road), a notification made in the case where the mobile object moves unstably, a notification made in the case where an emergency vehicle passes by the mobile object, a notification made in the case where the mobile object approaches another object (such as an obstacle, for example), a notification made in the case where an accident has happened near the mobile object, a notification made in the case where wakefulness of the target has fallen below a threshold (such as a case where the target is so sleepy, for example), and the like. Note that, the types of notification are not necessarily limited to the above-described examples. For example, the examples of the notification may include notifications made at times other than when abnormality occurs, such as a notification of reception of an e-mail, a notification of reception of a message, a notification of an incoming call, and a notification made by a navigation device (such as a notification related to a route to a destination, for example). Hereinafter, such events that trigger the notifications will be referred to as “annunciation events”.

### (Tactile Sense Provision Section 200)

The tactile sense provision section 200 is a structural element that provides the above-described tactile stimulus to at least a part of a body of the target while the target is operating the mobile object. The tactile sense provision section 200 is installed in a controller to be used for operating the mobile object, an armrest, a seat, a seat belt, or the like. The tactile sense provision section 200 provides the tactile stimulus to the target when the target comes into contact with the controller, armrest, seat, seat belt, or the like. Note that, the device provided with the tactile sense provision section 200 is not necessarily limited to the above-described examples. Any device may be used as long as the target can come into contact with the device. In addition, the position (arrangement) of the tactile sense provision section 200 in such a device may be any position (arrangement) as long as the target can come into contact with the position (arrangement) of the tactile sense provision section 200. According to the present embodiment, an example in which the tactile sense provision section 200 is a steering wheel will be mainly described. The steering wheel is a type of controller.

Alternatively, the tactile sense provision section 200 may be implemented by various devices depending on the types of tactile stimuli to be provided to the target. For example, in the case of providing the vibratory stimulus, the tactile sense provision section 200 may be implemented by an actuator (such as an eccentric motor, linear resonant actuator, or voice coil motor, for example). Alternatively, in the case of providing the electric stimulus, the stimulus related to a sense of force, or the stimulus related to the cutaneous sense, the tactile sense provision section 200 may be implemented by various kinds of electric elements. Alternatively, in the case of providing the temperature change stimulus, the tactile sense provision section 200 may be implemented by a temperature change element (such as a Peltier element, for example). Note that, the devices for implementing the tactile sense provision section 200 are not necessarily limited to the above-described examples.

### (Control Device 100)

The control device 100 is a device that controls a mode of the tactile stimulus to be provided to the target. For example, the control device 100 may be implemented by an electronic control unit (ECU) installed in a car. Note that, the device for implementing the control device 100 is not necessarily limited to the ECU. For example, the control device 100 may be implemented by a microcontroller or the like included in the ECU. Alternatively, the control device 100 may be implemented by an external device (such as a cloud server, smartphone, or another mobile object, for example), which is not installed in the car. As illustrated in FIG. 1, the control device 100 includes a control section 110, a communication section 120, and a storage section 130.

### (Control Section 110)

The control section 110 is a structural element that integrally controls overall processes performed by the control device 100. For example, the control section 110 makes it possible to control start and stop of the respective structural elements. For example, the control section 110 may be implemented by a processor such as a central processing unit (CPU) or a microcontroller unit (MCU). Note that, contents of the control of the control section 110 are not limited thereto. As illustrated in FIG. 1, the control section 110 includes a contact degree detection section 111 and a tactile sense provision control section 112.

### (Contact Degree Detection Section 111)

The contact degree detection section 111 is a structural element that detects a degree of contact between the target who operates the mobile object, and the tactile sense provision section 200 that provides the tactile stimulus to at least a part of the body of the target during the operation.

Here, the “degree of contact between the target and the tactile sense provision section 200” is an indicator that indicates a degree of contact between the target and the tactile sense provision section 200. Examples of the indicator indicating the degree of contact include intensity of the contact between the target and the tactile sense provision section 200 (such as intensity of grip force obtained when the target holds a steering wheel (tactile sense provision section 200), for example), area of the contact between the target and the tactile sense provision section 200 (such as the area of contact between the target and the steering wheel, for example), and a combination thereof.

The contact degree detection section 111 makes it possible to detect the degree of contact between the target and the tactile sense provision section 200 through various kinds of methods. For example, the contact degree detection section 111 may calculate load on the steering wheel by analyzing sensor data obtained from a load sensor installed in the whole or a part of the steering wheel serving as the tactile sense provision section 200, and may detect the degree of contact between the target and the tactile sense provision section 200 on the basis of the load.

In addition, the contact degree detection section 111 may detect the degree of contact between the target and the tactile sense provision section 200 on the basis of a detection result obtained by a ranging sensor that detects distances between the steering wheel and hands of the target. The ranging sensor may be installed in the steering wheel in such a manner that the ranging sensor detects remote distances between the steering wheel and hands of the target, or may be installed in an in-vehicle device other than the steering wheel in such a manner that the ranging sensor detects the remote distances between the steering wheel and hands of the target.

Alternatively, the contact degree detection section 111 may recognize a steering wheel holding state of the target by analyzing an image captured by a camera installed in the vehicle, and may detect the degree of contact between the target and the tactile sense provision section 200 on the basis of the steering wheel holding state. Alternatively, the contact degree detection section 111 may detect the degree of contact between the target and the tactile sense provision section 200 depending on a result obtained by analyzing a detection result, which is obtained by a sensor that is installed in the steering wheel for detecting capacitance. For example, the contact degree detection section 111 may detect that the degree of contact between the target and the tactile sense provision section 200 is large if the capacitance is large.

In addition, sometimes it is possible to estimate the degree of contact between the target and the tactile sense provision section 200 on the basis of a state of movement of the mobile object. For example, in the case where the car serving as the mobile object goes straight, there is a possibility that the target does not sufficiently hold the steering wheel serving as the tactile sense provision section 200. On the other hand, in the case where the car is turning to the right or left, in the case where the car is backed into a parking space, or in other cases, there is a high possibility that the target sufficiently holds the steering wheel to operate the car. Alternatively, in the case where the car is running in a stable environment (for example, an environment where wind blows gently), there is a possibility that the target does not sufficiently hold the steering wheel. On the other hand, in the case where the car is running in an unstable environment (such as strong wind, heavy rain, or blizzard, for example), there is a high possibility that the target sufficiently hold the steering wheel to stabilize the car running condition. Accordingly, the contact degree detection section 111 may recognize the state of movement of the mobile object as described above by analyzing the sensor data obtained from various kinds of sensors, and may estimate the degree of contact between the target and the tactile sense provision section 200 on the basis of the state of movement. Note that, the contact degree detection method used by the contact degree detection section 111 is not necessarily limited to the above-described examples. The contact degree detection section 111 provides a result of detecting the degree of contact to the tactile sense provision control section 112.

### (Tactile Sense Provision Control Section 112)

The tactile sense provision control section 112 is a structural element that controls the mode of tactile stimulus on the basis of the degree of contact between the target and the tactile sense provision section 200 in the case where the annunciation event occurs. More specifically, the tactile sense provision control section 112 first detects occurrence of the annunciation event. A detection method varies depending on the contents of the annunciation event. For example, in the case where the annunciation event indicates occurrence of abnormality (for example, a case where the mobile object is likely to deviate from the migration path or the like), the tactile sense provision control section 112 detects the occurrence of abnormality by analyzing sensor data obtained from various kinds of sensors. Alternatively, in the case where the annunciation event indicates occurrence of an event that is not abnormal such as an e-mail reception event, the tactile sense provision control section 112 detects occurrence of the annunciation event by communicating and cooperating with various kinds of devices (for example, an external device that has received the e-mail or the like). Next, in the case where the occurrence of the annunciation event is detected, the tactile sense provision control section 112 generates a control signal for controlling the tactile sense provision section 200, and provides the signal to the tactile sense provision section 200 via the communication section 120. This allows the tactile sense provision section 200 to provide a tactile stimulus. As described above, it is possible for the tactile sense provision control section 112 to notify the target alone by means of the tactile stimulus, unlike the case of using a stimulus such as sound, wind, or aroma.

To provide the tactile stimulus, the tactile sense provision control section 112 controls the mode of tactile stimulus on the basis of a result of detecting the degree of contact between the target and the tactile sense provision section 200. The result of detection is provided by the contact degree detection section 111. More specifically, the tactile sense provision control section 112 increases sensitivity of the target to the tactile stimulus by changing the mode of tactile stimulus, in the case where the degree of contact between the target and the tactile sense provision section 200 falls below a threshold (in other words, in the case where the target is not in sufficient contact with the tactile sense provision section 200).

Examples of a specific method of increasing the sensitivity to a tactile stimulus include increase in intensity of a stimulus (hereinafter, referred to as stimulus intensity) provided as the tactile stimulus, and increase in length of time to provide the tactile stimulus. In addition, the examples of the specific method of increasing the sensitivity to the tactile stimulus include shortening of an interval between provision of the respective tactile stimuli (hereinafter, referred to as a provision interval), and increase in the number of times of providing the tactile stimulus (hereinafter, referred to as provision frequency), on an assumption that the annunciation event occurs and then the tactile stimulus is provided more than once.

In addition, the examples of the specific method of increasing the sensitivity to the tactile stimulus may include increase in a value (hereinafter, referred to as value of integral) obtained by integrating intensity of the tactile stimulus provided when the single annunciation event occurs, with respect to a provision time period. In addition, the tactile sense provision control section 112 may control the mode of tactile stimulus by combining the above-described factors.

Accordingly, it is possible for the tactile sense provision control section 112 to notify the target by means of the tactile stimulus more appropriately, without being affected by the degree of contact between the target and the tactile sense provision section 200. For example, even in the case where the degree of contact between the target and the tactile sense provision section 200 falls below the threshold, it is possible for the tactile sense provision control section 112 to allow the target to perceive the tactile stimulus more certainly, by increasing the intensity of tactile stimulus or in other ways. In addition, in the case where the degree of contact between the target and the tactile sense provision section 200 is higher than the threshold, it is possible for the tactile sense provision control section 112 to maintain the intensity of the tactile stimulus without increasing the intensity more, and prevent the target from feeling discomfort in that the intensity of the tactile stimulus is too strong, for example. It can be said that this is particularly helpful in a technical field (such as an automotive field, for example) that makes it possible to achieve safe driving even in the case where the target does not sufficiently hold the controller (such as the steering wheel, for example), by development of driving assistance technologies such as adaptive cruise control (ACC) and self-driving technologies.

To achieve the above-described functions, the tactile sense provision control section 112 adjusts a parameter related to the intensity, provision time, provision interval, or number of times of provision of the tactile stimulus to a value that makes the target to feel discomfort, and then generates a control signal that reflects the parameter. The contents of the parameter depend on the type of tactile stimulus. For example, in the case where the tactile stimulus is the vibratory stimulus, the tactile sense provision control section 112 adjusts frequency, acceleration, or the like related to provision of the vibratory stimulus, as the parameter.

Here, the “threshold” used for the above-described control is not necessarily limited to a single threshold. For example, the tactile sense provision control section 112 may change the above-described factor (such as the intensity of tactile stimulus, for example) step by step by preparing a plurality of thresholds. This allows the tactile sense provision control section 112 to control the mode of tactile stimulus more precisely. Note that, as described above, “the control over the mode of tactile stimulus depending on a result of comparison between the degree of contact and the threshold” is equivalent to “the control over the mode of tactile stimulus depending on the degree of contact” (such as a case where the modes of tactile stimulus are associated with the degrees of contact, for example).

In addition, the tactile sense provision control section 112 may increase the sensitivity of the target to the tactile stimulus by changing the mode of tactile stimulus, in the case where the degree of contact between the target and the tactile sense provision section 200 is higher than a threshold (which may be different from the above-described thresholds) (in other words, in the case where the target is in sufficient contact with the tactile sense provision section 200). For example, in the case where the degree of contact between the target and the tactile sense provision section 200 is higher than the threshold, the tactile sense provision control section 112 may reduce the sensitivity of the target to the tactile stimulus by reducing the intensity of tactile stimulus more, by shortening the time of providing the tactile stimulus, by extending the intervals between the provision of the tactile stimulus, or by reducing the number of times of provision of the tactile stimulus. Alternatively, the tactile sense provision control section 112 may reduce the sensitivity of the target to the tactile stimulus by further reducing the value of integral of the tactile stimulus provided when the single annunciation event occurs. In addition, the tactile sense provision control section 112 may control the mode of tactile stimulus by combining the above-described factors. Accordingly, even in the case where the degree of contact between the target and the tactile sense provision section 200 is higher than the threshold, it is possible for the tactile sense provision control section 112 to prevent the target from feeling discomfort in that the intensity of the tactile stimulus is too strong, for example.

### (Communication Section 120)

The communication section 120 is a structural element that transmits/receives information to/from an outside structural element or device. For example, in the case where various kinds of sensors acquire sensor data that is used for detecting the degree of contact between the target and the tactile sense provision section 200, the communication section 120 receives the sensor data from the sensors. In addition, in the case where the tactile sense provision control section 112 generates a control signal that is used for controlling the tactile sense provision section 200, the communication section 120 transmits the control signal to the tactile sense provision section 200. Note that, contents of the information transmitted/received by the communication section 120 are not necessarily limited to the above-described information. In addition, a method of transmitting/receiving the information from/to the communication section 120 is not specifically limited.

### (Storage Section 130)

The storage section 130 is a structural element that stores various kinds of information. For example, the storage section 130 stores a program, a parameter, and the like, which are used by the control section 110 and the communication section 120. In addition, the storage section 130 may store a processing result of the control section 110, information received by the communication section 120 from an external device, and the like. Note that, contents of the information stored in the storage section 130 are not limited to the above-described examples. For example, the storage section 130 may be implemented by read-only memory (ROM), random-access memory (RAM), or the like. However, the storage section 130 is not necessarily limited thereto.

The configuration example of the system 1 according to the present embodiment has been described above. Note that, the configuration described above with reference to FIG. 1 is a mere example. The configuration of the control system 1 according to the present embodiment is not limited thereto. For example, the number of control devices 100 and the number of tactile sense provision sections 200 are not specifically limited. In addition, the control device 100 does not have to include some of the structural elements illustrated in FIG. 1, or the control device 100 may include a structural element that is not illustrated in FIG. 1. In addition, a structural element of the control device 100 illustrated in FIG. 1 may be installed in the external device (not illustrated), and the above-described functions may be achieved when the control device 100 communicates and cooperates with the external device.

### <2. Processing Flow Example>

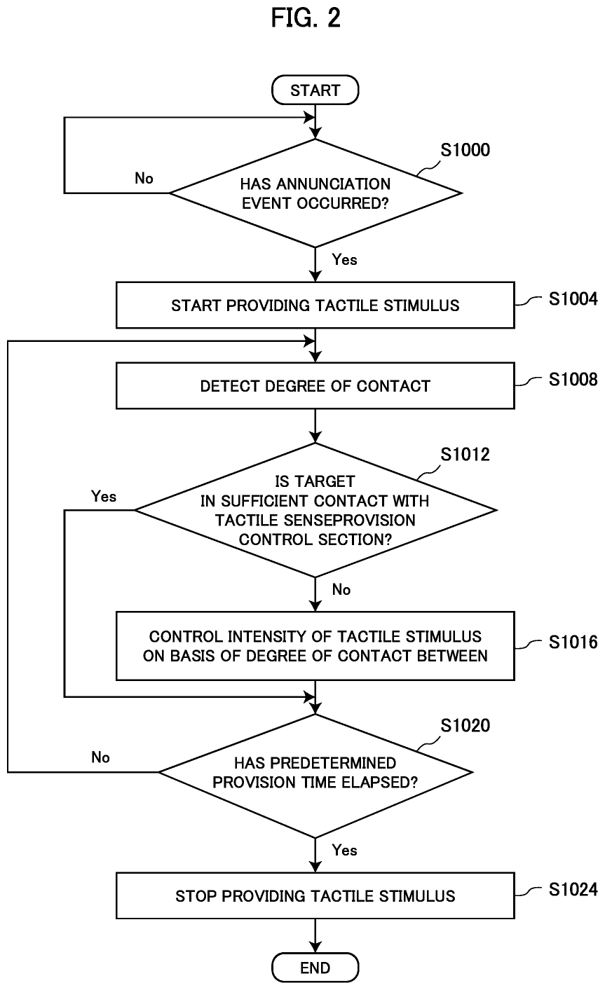

The configuration example of the control system 1 according to the present embodiment has been described above. Next, an example of a flow of a tactile stimulus provision control process performed by the control device 100 according to the present embodiment will be described with reference to FIG. 2. FIG. 2 is a flowchart illustrating an example of a flow of a tactile stimulus provision control process that is performed by the control device 100 according to the present embodiment.

In Step S1000, the tactile sense provision control section 112 of the control device 100 determines whether or not the annunciation event has occurred. For example, the tactile sense provision control section 112 detects occurrence of abnormality by analyzing sensor data obtained from the various kinds of sensors, or detect reception of an e-mail or the like by communicating and cooperating with various kinds of devices. Note that, as described above, the contents of the annunciation event and the method of detecting the annunciation event are not necessarily limited thereto.

In the case where the annunciation event has occurred (YES in Step S1000), the provision of a tactile stimulus starts in Step S1004. More specifically, the tactile sense provision control section 112 generates a control signal for controlling the tactile sense provision section 200, and provides the signal to the tactile sense provision section 200 via the communication section 120. This allows the tactile sense provision section 200 to start providing the tactile stimulus.

In Step S1008, the contact degree detection section 111 detects the degree of contact between the target and the tactile sense provision section 200. More specifically, the contact degree detection section 111 detects the degree of contact between the target and the tactile sense provision section 200 by analyzing sensor data obtained from various kinds of sensors (such as the load sensor and the ranging sensor installed in the tactile sense provision section 200, and the camera installed in the vehicle, for example).

In Step S1012, the tactile sense provision control section 112 determines whether or not the target is in sufficient contact with the tactile sense provision control section 200, on the basis of a result of detecting the degree of contact between the target and the tactile sense provision control section 200. The result is provided by the contact degree detection section 111. More specifically, the tactile sense provision control section 112 compares the degree of contact between the target and the tactile sense provision section 200 with a threshold.

In the case where the target is not in sufficient contact with the tactile sense provision section 200 (NO in Step S1012), the tactile sense provision control section 112 controls the mode of tactile stimulus on the basis of the degree of contact between the target and the tactile sense provision section 200 in Step S1016. For example, the tactile sense provision control section 112 increase the sensitivity of the target to the tactile stimulus by changing the intensity, provision time, provision interval, number of times of provision of the tactile stimulus, or the like. Note that, the process in Step S1016 is not performed in the case where the target is in sufficient contact with the tactile sense provision section 200 (YES in Step S1012).

In Step S1020, the tactile sense provision control section 112 determines whether or not a predetermined provision time has elapsed since the provision of the tactile stimulus has started. In the case where the predetermined provision time has elapsed (YES in Step S1020), the tactile sense provision control section 112 stops providing the tactile stimulus in Step S1024. Therefore, the series of processes ends. In other words, the tactile sense provision control section 112 stops generating the control signal to be used for providing the tactile stimulus. In the case where the predetermined provision time has not elapsed (NO in Step S1020), the process returns to Step S1008. In other words, the processes in Step S1008 to Step S1020 are repeated until the predetermined provision time elapses.

The processes illustrated in FIG. 2 are repeated while the mobile object is moving in response to the operation performed by the target (however, the present invention is not limited thereto). In addition, the processes in the flowchart illustrated in FIG. 2 are not necessarily processed in time sequence in the order illustrated in FIG. 2. Therefore, the steps in the flowchart may be processed in a different order from the order illustrated in FIG. 2, or may be processed in parallel.

### CONCLUSION

As described above, the control device 100 according to the present embodiment detects a degree of contact between the target who operates the mobile object, and the tactile sense provision section 200 that provides the tactile stimulus to at least a part of the body of the target during the operation, and controls the mode of tactile stimulus on the basis of the degree of contact. More specifically, the tactile sense provision control section 112 increases sensitivity of the target to the tactile stimulus by changing the mode of tactile stimulus, in the case where the degree of contact between the target and the tactile sense provision section 200 falls below a threshold (in other words, in the case where the target is not in sufficient contact with the tactile sense provision section 200).

Accordingly, it is possible for the tactile sense provision control section 112 to notify the target by means of the tactile stimulus more appropriately, without being affected by the degree of contact between the target and the tactile sense provision section 200. For example, even in the case where the degree of contact between the target and the tactile sense provision section 200 falls below the threshold, it is possible for the tactile sense provision control section 112 to allow the target to perceive the tactile stimulus more certainly, by increasing the intensity of tactile stimulus or in other ways. In addition, in the case where the degree of contact between the target and the tactile sense provision section 200 is higher than the threshold, it is possible for the tactile sense provision control section 112 to maintain the intensity of the tactile stimulus without increasing the intensity more, and prevent the target from feeling discomfort in that the intensity of the tactile stimulus is too strong, for example.

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

### REFERENCE SIGNS LIST

1 control system

100 control device

110 control section

111 contact degree detection section

112 tactile sense provision control section

120 communication section

130 storage section

200 tactile sense provision section

1. A control device comprising:
a contact degree detection section configured to detect a degree of contact between a target who operates a mobile object, and a tactile sense provision section that provides a tactile stimulus to at least a part of a body of the target during the operation; and
a tactile sense provision control section configured to control a mode of the tactile stimulus to be provided by the tactile sense provision section, on a basis of the degree of contact.

2. The control device according to claim 1,
wherein, in a case where the degree of contact falls below a threshold, the tactile sense provision control section changes the mode of the tactile stimulus in such a manner that the target has an increased sensitivity to the tactile stimulus.

3. The control device according to claim 2,
wherein, in a case where the degree of contact falls below the threshold, the tactile sense provision control section increases the sensitivity by chancing at least one of intensity, provision time, provision interval, and number of times of provision of the tactile stimulus.

4. The control device according to claim 1,
wherein the degree of contact includes intensity of the contact between the target and the tactile sense provision section or area of the contact between the target and the tactile sense provision section.

5. The control device according to claim 1,
wherein the contact degree detection section estimates the degree of contact on a basis of a state of movement of the mobile object.

6. The control device according to claim 1,
wherein the tactile stimulus includes a vibratory stimulus, an electric stimulus, a stimulus provided when temperature changes, a stimulus related to a sense of force, or a stimulus related to a cutaneous sense.

7. The control device according to claim 1,
wherein the tactile sense provision control section causes the tactile sense provision section to provide the tactile stimulus when an event to be announced occurs.

8. The control device according to claim 1,
wherein the mobile object includes a real or virtual vehicle, airplane, or ship.

9. The control device according to claim 8,
wherein the tactile sense provision section is installed in a controller to be used for the operation, an armrest, a seat, or a seat belt.

10. A non-transitory computer readable storage medium having a program stored therein, the program causing a computer to:
detect a degree of contact between a target who operates a mobile object, and a tactile sense provision section that provides a tactile stimulus to at least a part of a body of the target the during operation; and
control a mode of the tactile stimulus to be provided by the tactile sense provision section, on a basis of the degree of contact.
